(19) United States
(12) Patent Application Publication
(10) Pub. No.: US 2002/0117557 A1
(43) Pub. Date: Aug. 29, 2002

(54) Modularly designed injector for fuel injection

(76) Inventors: Roger Potschin, Brackenheim (DE); Ulrich Projahn, Leonberg (DE)

Correspondence Address: GREIGG & GREIGG P.L.L.C., 1423 Powhatan Street, Unit One, Alexandria, VA, 22314, US

(21) Appl. No.: 09/994,898

(22) Filed: Nov. 28, 2001

(30) Foreign Application Priority Data
Dec. 1, 2000 (DE) 1 00 59 628.2

(51) Int. Cl. F02M 47/02

(52) U.S. Cl. 239/88

(57) ABSTRACT

The invention relates to an injector for injecting fuel into the combustion chambers of an internal combustion engine, where the fuel compressed in a compression unit can be supplied via a pressure line to a nozzle chamber, which encompasses a nozzle needle of the injector. This nozzle chamber communicates with the injection nozzle protruding into the combustion chamber of the internal combustion engine, where the injector contains a fluid control unit. The fluid control unit is embodied as a hydraulic module, which is replaceably disposed in the housing of the injector and can either be actuated by an actuator or can be electromagnetically actuated.

### BACKGROUND OF THE INVENTION

1. Field Of The Invention

This invention relates to fuel injectors and more particularly to an improved fuel injector for injecting fuel with an internal combustion engine.

2. Brief Description Of The Prior Art

Continuously increasing demands on motor vehicle emissions require combustion events to occur in the internal combustion engine in such a way that, in addition to an optimal fuel consumption, an optimal, i.e. clean, combustion is achieved. The combustion occurring in an internal combustion engine can be significantly influenced by forming, i.e. influencing, the discharge rate curve. The formation of the discharge rate curve requires on the one hand, flexibly functioning and flexibly designed injection systems whose manufacturing and development costs, on the other hand, must be justifiable.

EP 0823549 A2 relates to an injector device for fuel injection in which armature element actuates both a discharge valve and a control needle valve, which regulates the pressure in a control chamber. When the control chamber is acted on with highly pressurized fuel, a force, which assists the force of a compression spring, is exerted on the control part. The discharge valve and the control needle valve are controlled by a common component by means of an electromagnetic triggering. In this embodiment, which is known from the prior art, the control needle valve and the top parts of the control needle valve constitute parts of a control chamber and are dimensioned so that the control needle valve is essentially pressure-balanced on all sides. In the selected embodiment according to EP 0 823 549 A2, the control part members, i.e. the control part and the needle valve on the injection valve, are triggered as a function of the corresponding flow level, where the needle valve is partially actuated by means of a mechanical coupling. In this embodiment from the prior art, precisely maintaining adjustment parameters is problematic; furthermore, a decoupling of the stroke events of the two valves connected in series can only be achieved with difficulty in the embodiment according to EP 0 823 549 A2.

DE 100 12 552 A1 relates to an injection device with an actuator for needle stroke control. The injector disclosed in this publication contains two control valves whose discharge sides are connected to regions with low pressure levels. One of the control valves that form the discharge rate curve contains a pressure balancing system by means of which the injection pressure curve can be varied by changing the stroke path of the nozzle needle.

DE 100 14 450 relates to a device for injecting fuel with a variable injection pressure curve. In this embodiment, a high-pressure line extending through an injector housing leads from the pressure chamber of the injector, which injector housing contains a nozzle that can be closed by means of a nozzle needle. The nozzle needle is acted on by means of a fuel reservoir. In this embodiment, control valves are provided, which can be adjusted independently of each other by means of an actuator element, which communicate with each other via a coupling chamber, and which can be used to control the injection pressure curve.

### SUMMARY OF THE INVENTION

According to the embodiment proposed according to the invention, a replaceably configured hydraulic module, which can be used to produce individually formable discharge rate curves is incorporated by means of an injector, which injects highly pressurized fuel. When the requirements of the injector that is injecting the fuel change, the hydraulic modules in the injector, which produce the different injection pressure curves, need only be replaced; the rest of the injector can be taken unchanged from the current series in accordance with the principle of replaceable part use and need not be modified. The modular design of the injector permits the discharge rate curve to be simply adapted to the respective client requirements, i.e. to the respective intended use of an injector in internal combustion engines, whether they are in passenger or commercial vehicles, without having to produce a specialized pump apparatus for each case. The modifications that produce the individual injection pressure curves are thus reflected solely in the replaceably configured hydraulic module, which in one embodiment of the concept underlying the invention, can be embodied as an actuator-actuated hydraulic module, where preferably piezoelectric actuators can be used. In another embodiment of the replaceable hydraulic module proposed according to the invention, it can also be embodied as a hydraulic module that can be actuated by means of electromagnets that are integrated into it.

The modularity of the hydraulic module can be achieved by using a piezoelectric actuator, which acts on a hydraulic coupling chamber of two control valves contained in the hydraulic module and acts on them in a parallel fashion. When a piezoelectric actuator is used, two control valves can be actuated. This permits a simpler design of the control unit to be achieved since only a simple plug connector is required due to a lower number of pins. A simpler driver stage can therefore be achieved in the control unit; furthermore, there is less power loss in the control unit.

The hydraulic actuation of the valves contained in the hydraulic module permits the piezoelectric actuator to be disposed so that it is spatially decoupled from the control valves of the hydraulic module. Consequently, there is an additional degree of freedom in the design of the hydraulic module. Furthermore, the control valves can be disposed in parallel with each other, which has a positive effect on the height of the hydraulic module to be integrated into the injector body. The parallel disposition of the control valves in the hydraulic module also permits the valves to be completed and adjusted independently of each other. Tolerances in one of the control valves or a change in the functional parameters such as valve stroke changes that occur over the service life of the control valves or changes in the valve prestressing force do not affect functional changes in the other control valve.

In addition to the replaceably configured hydraulic module being embodied as an actuator-actuated hydraulic module, it can also be embodied as an electromagnetically actuated hydraulic module. To that end, two electromagnet coils are contained in the hydraulic module, which are essentially arranged in parallel with each other. The electromagnet coils, whether they are encased by the material of the hydraulic module body or whether they are incorporated into high quality soft-magnetic components inside the hydraulic module, each act on a respective control valve.

When replaceable hydraulic modules are used, which are accommodated in the injector for fuel injection, the interfaces of the hydraulic modules, whether they are actuator-actuated or electromagnetically actuated, must be assured of permitting a simple replacement, preferably without tools, on the end oriented toward the injection nozzle and on the end oriented away from it. As a result, the pump unit, which acts on the hydraulic module and compresses the fuel to a higher pressure level, the nozzle needle configuration, i.e. the support of the nozzle needle, and the nozzle chamber, can be embodied in an essentially standardized form. This has an advantageous influence on the production costs since varying the embodiment requires only adaptations to the hydraulic module, large numbers of which can be produced and stored in various embodiments, since this component decisively determines the injection pressure curve of an injector. In contrast to the embodiments known from the prior art, in which forming the discharge rate curve requires further modifications to the injector that do not relate exclusively to the replacement of the hydraulic module, with the embodiment proposed according to the invention, the requirements in the formation of an injection pressure curve can largely be taken into account.

### BRIEF DESCRIPTION OF THE DRAWINGS

The invention will be explained in detail below in conjunction with the drawings, in which:

FIG. 1 shows a schematic diagram of an injector whose replaceable hydraulic module contains 2/2-way valves with throttle elements,

FIG. 1 a shows the injection pressure curve that can be produced with the injector configured according to FIG. 1, plotted over time,

FIG. 2 shows an embodiment of a hydraulic module, with a control chamber that acts on an actuating piston of the injector body,

FIG. 2a shows the injection pressure curve at the injection nozzle, which curve is produced with the injector according to FIG. 2,

FIGS. 3, 4 and 5 show different embodiments of an actuator-actuated hydraulic module,

FIGS. 3a, 4a and 5 the injection pressure curves that can be produced with the use of the hydraulic module according to FIGS. 3, 4, and 5, respectively plotted over time,

FIG. 6 shows a schematic diagram of an electromagnetically actuated hydraulic module,

FIG. 6a shows the injection pressure curve of an injection nozzle, which curve is produced with the use of the hydraulic module according to FIG. 6,

FIG. 7 shows an exemplary embodiment of an actuator that can be electromagnetically actuated, with a control valve that is connected in parallel to it, and

FIG. 8 shows the electromagnetically actuated hydraulic module incorporated into an injector.

### DESCRIPTION OF THE PREFERRED EMBODIMENTS

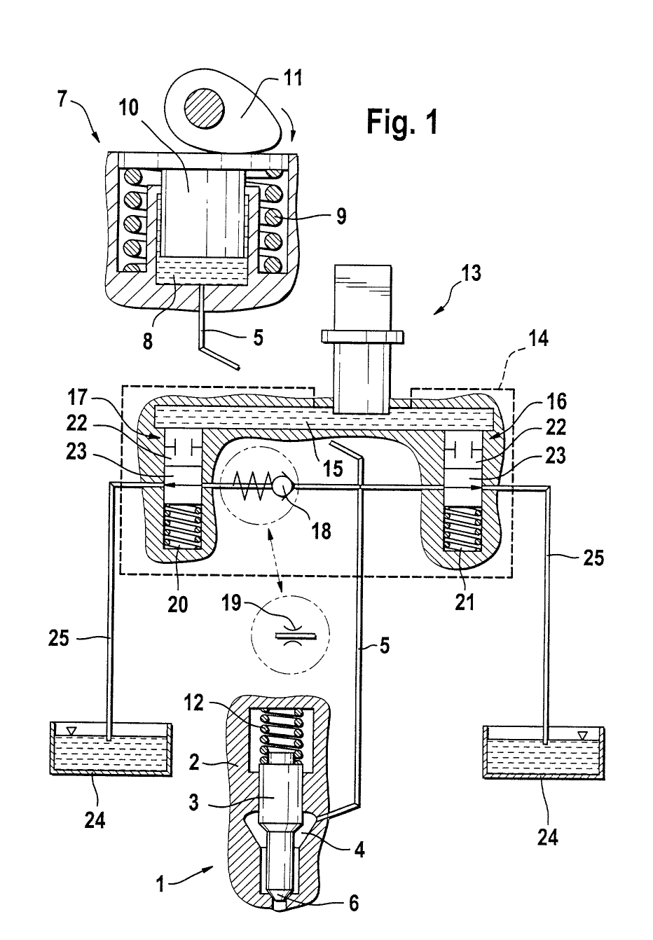

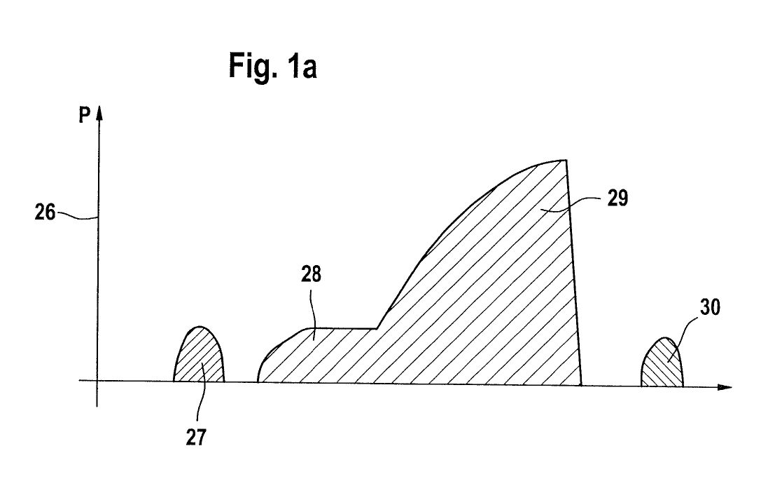

It can be inferred from the depiction in FIG. 1 that the injector 1 contains an injector housing 2, whose front region contains a nozzle needle 3. The nozzle needle 3 is enclosed at its bottom end by a nozzle chamber 4, which is fed by a pressure line 5. The pressure line 5 communicates with a pump chamber 8 of a compression unit 7, which is only depicted in schematic fashion here. The nozzle chamber 4 is adjoined by an annular conduit in the injector housing 2 of the injector 1, which annular conduit encompasses the nozzle needle 3 in its tapered region and in the vicinity of the injection nozzle opening, feeds into the combustion chamber of a cylinder of an internal combustion engine.

The compression unit 7-only depicted in schematic fashion here-includes a pump chamber 8, in which a piston element 10 can move in the vertical direction. The piston element 10 has a disk-shaped plate, which is supported on a compression spring 9 encompassing the cylinder of the compression unit 7. In the schematic depiction shown here from FIG. 1, the piston element 10 is moved up and down by a rotating cam element 11, which is eccentrically supported on a shaft. As a result, pressure pulsations occur in the pump chamber 8 of the compression unit 7 so that the fuel volume contained in the pump chamber 8 is subjected to a higher pressure and enters into the pressure line 5 to the nozzle chamber 4 at a higher pressure.

The injector housing 2 contains a nozzle needle spring 12 that acts on the nozzle needle 3 and is supported against the injector housing 2. A dashed line surrounds the hydraulic module 14 that can be inferred from FIG. 1, which according to the configuration from FIG. 1, is actuated by means of an actuator element 13. In a preferred embodiment, the actuator element 13 is embodied as piezoelectric actuator. The piston of the piezoelectric actuator 13 acts on a coupling chamber 15, by which the two control valves 16 and 17 of the hydraulic module 14 can be actuated in parallel and which contains a control volume. According to the configuration from FIG. 1, the control valves 16 and 17 of the hydraulic module 14 are embodied as 2/2-way valves, which can be switched into two positions. In a first switch position 22, the 2/2-way valves 16 and 17 assume their closed position, while in the switch state indicated with the position number 23, they assume their open through flow position. Viewed in the flow direction from the pressure line 5, a constant pressure valve 18 is associated with one of the two control valves 16 and 17. In its open position, i.e. through flow position 23, the constant pressure valve 18 associated with the second control valve 17 permits a pressure increase phase 28 to be achieved, which is depicted in detail in FIG. 1a and is characterized by a constant pressure level; with the use of a constant pressure valve 18, independent of all speeds and system parameters, this constant pressure level is a function of the pressure level that can be adjusted at the constant pressure valve.

In addition to the use of a constant pressure valve of the kind shown in the embodiment according to FIG. 1, a throttle element 19 can also be connected upstream of the second control valve 17. As an alternative to the constant pressure valve, this throttle element 19 can inserted into the supply line leading from the pressure line 5 to the second control valve 17.

The second control valve 17 is followed by a discharge line 25, which feeds into a reservoir 24. Opposite the branch to the second control valve 17, there is a branch to the first control valve 16, which is likewise embodied as a 2/2-way valve that can be switched from a closed position 22 into an open position 23 and vice versa. Both of the control valves 16 and 17 are associated with restoring elements 20 and 21, which for production engineering reasons, can be embodied in a particularly simpler fashion as restoring springs. The first control valve 16 is also followed by a discharge line 25, which feeds into a reservoir 24.

If the control valves 16 and 17 are moved into their closed position 22 through the action of the actuator 13, the branches from the pressure line 5 are closed and the full pressure prevails in the nozzle chamber 4, which encompasses the nozzle needle 3, so that an injection can occur. By momentarily opening and closing, the first control valve 16 can produce a preinjection 27 and/or a secondary injection 30, while the absolute pressure of the pressure increase phase 28 (boot phase) can be adjusted by means of the constant pressure element 18 connected upstream of the second control valve 17—alternatively a throttle element 19.

FIG. 1a shows a detained depiction of the injection pressure curve that can be produced with an injector configured according to FIG. 1, plotted over time. The reference numeral 26 indicates the curve of the injection pressure at the tip of the injection nozzle. The injection that can be produced with the hydraulic module schematically depicted in FIG. 1 can essentially be divided into a preinjection phase 27 at a relatively low pressure level, which is followed by a pressure increase phase 28. The pressure increase phase 28 is essentially characterized by means of a constant pressure level, which is significantly lower than the main injection phase 29 that comes after the pressure increase phase 28. The essentially constant pressure level of the pressure increase phase 28 is determined by the design of the throttle element 19 or is determined by the opening pressure of the valve that can be adjusted at the constant pressure valve and can be influenced by these parameters.

If both control valves 16 and 17 according to the configuration from FIG. 1 are moved into their closed position 22, the full pressure gradient of the high fuel pressure produced in the compression unit 7 prevails in the nozzle chamber 4 of the injector housing 2 so that the injection into the combustion chamber can take place.

The main injection is followed by a secondary injection 30, whose maximum pressure is approximately comparable to the maximum pressure occurring during the preinjection phase 27, but can also exceed the maximum pressure of the preinjection quantity as the secondary injection quantity increases.

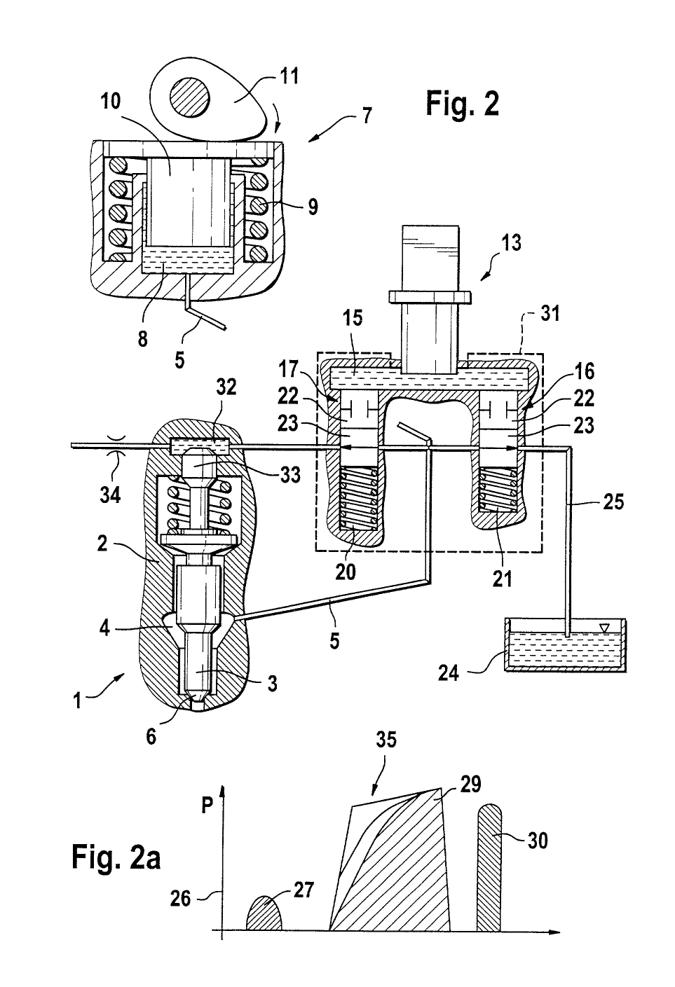

FIG. 2 shows an embodiment of a hydraulic module with a control chamber inside the injector housing, which control chamber acts on an actuating piston in the injector.

In contrast to the schematic diagram that is described in connection with FIG. 1, which depicts an injector configured according to the invention that is for injecting highly pressurized fuel, the nozzle needle 3 according to FIG. 2, which is contained in the injector housing 2, is provided with an actuating piston 33. The actuating piston 33 of the nozzle needle 3 protrudes with a surface into a control chamber 32 that is embodied in the injector housing 2. According to this embodiment, not only can the nozzle chamber 4 be acted on by highly pressurized fuel via the pressure line 5, but also the control chamber 32, whose discharge side can be connected to a discharge throttle 34, can be acted on by means of the second control valve 17 of a modified hydraulic module 31. As a result, the pressure curves labeled with the reference numeral 35 in FIG. 1 can occur, since there is now an additional possibility for triggering the nozzle needle 3. Therefore the hydraulic module 31 shown in FIG. 2 is modified by virtue of the fact that it does in fact contain two control valves 16 and 17, which can be embodied as 2/2-way valves, but where the second control valve 17 is not proceeded by a throttle element in the form of a throttle 19 shown in FIG. 1 or a constant pressure valve 18. As a result, the injector into which a modified hydraulic module 31 is incorporated is also not in a position-see the depiction of the injection pressure curve according to FIG. 2a—to produce a pressure increase phase during the discharge rate curve, which is to precede the main injection 29.

The design of the compression element 7, discharge lines, and injector housing in the vicinity of the injection nozzle is analogous to the embodiment of an injector proposed according to the invention, which has already been described in conjunction with FIG. 1.

FIG. 2a shows the injection pressure curve, which occurs with the embodiment of the hydraulic module according to FIG. 2 and is essentially characterized by the lack of a pressure increase phase 28, but the curve of the pressure increase during the main injection phase 29 can follow various gradients 35. In comparison to the depiction in FIG. 1a, with the embodiment of the piezoelectric actuator-actuated hydraulic module 31 according to the schematic diagram in FIG. 2, a secondary injection 30 can be produced, which, in contrast with the preinjection 27, has a significantly higher pressure peak that corresponds approximately to the maximal injection pressure occurring during the main injection phase 29.

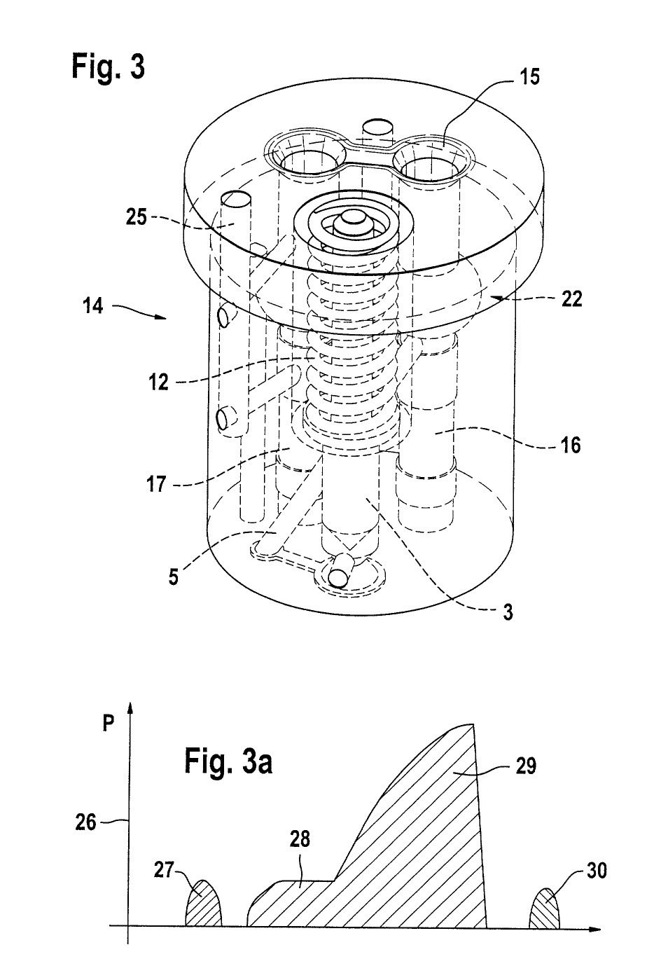

FIGS. 3, 4, and 5 show embodiments of an actuator-actuated hydraulic module in more detail.

The hydraulic modules 14, 31, and 36 shown in FIGS. 3, 4, and 5 are all hydraulic modules that can be actuated by means of an actuator 13, preferably a piezoelectric actuator, in which the actuator 13 acts on a coupling chamber 15 or 39, which is embodied on the end of the hydraulic module 14, 31, or 36 oriented away from the injection nozzle 6. The coupling chamber 15 or 39 therefore represents the interface to the standard-configuration injector housing 2. The end of the actuator-actuated hydraulic module 14, 31, and 36 oriented toward the injection nozzle 6 is essentially defined by the hydraulic coupling chamber 15 or 39 provided there, whereas the installation position of the actuator-actuated hydraulic module 14, 31, and 36 in the injector housing 2 can be defined by the position of the valve openings of the two control valves 16 and 17 in the injector housing 2.

The hydraulic module 14 shown in FIG. 3 corresponds essentially to the schematic diagram described in FIG. 1; the pressure curve reproduced in FIG. 3a corresponds to the pressure curve shown in FIG. 1a, with a preinjection phase 27, pressure increase phase 28 (boot phase), main injection phase 29, and secondary injection 30, which has a pressure maximum identical to that of the preinjection 27.

The fact that the pressure relief valve 18 of an injector 1 is partially encompassed by the nozzle needle spring 12 can be inferred from the depiction according to FIG. 3.

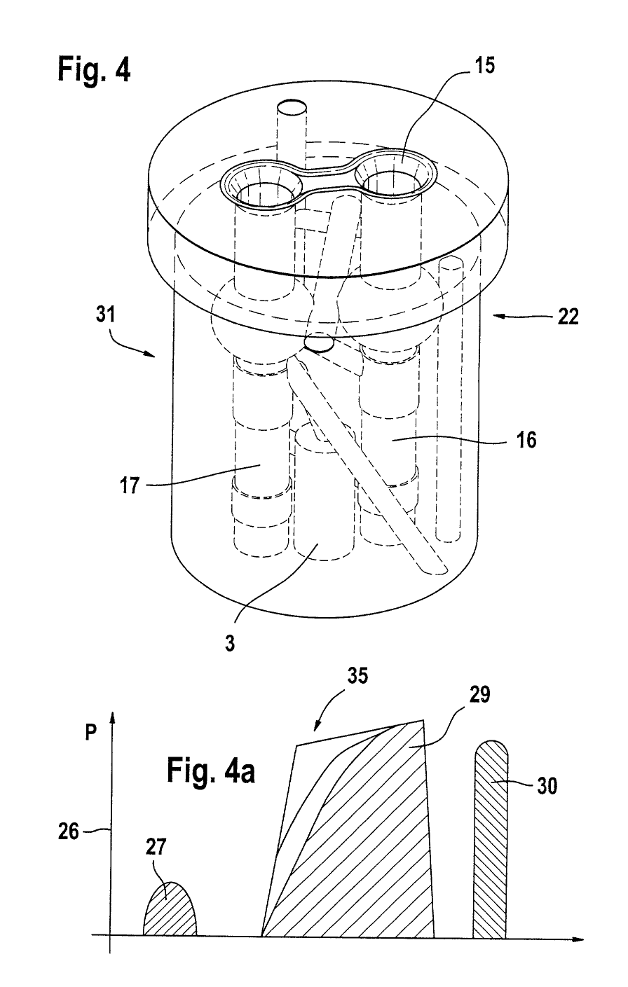

The depiction according to FIG. 4 shows the hydraulic module 31 in detail, whose schematic diagram has already been explained in connection with the figure description of FIG. 2; furthermore, FIG. 4a shows the pressure curve occurring in an injector in which the modified hydraulic module 31 is used as the hydraulic module, which contains two control valves 16, 17 essentially disposed in parallel with each other, which are preferably embodied as 2/2-way valves. The reference numeral 22 is used to label the closed position of the two valve bodies of the control valves 16 and 17, while position 15 indicates the hydraulic coupling chamber of the two control valves 16, 17 via which these valves can be actuated in parallel by means of a piezoelectric actuator 13. The injection pressure curve shown in FIG. 4a corresponds essentially to the injection pressure curve shown in FIG. 2a.

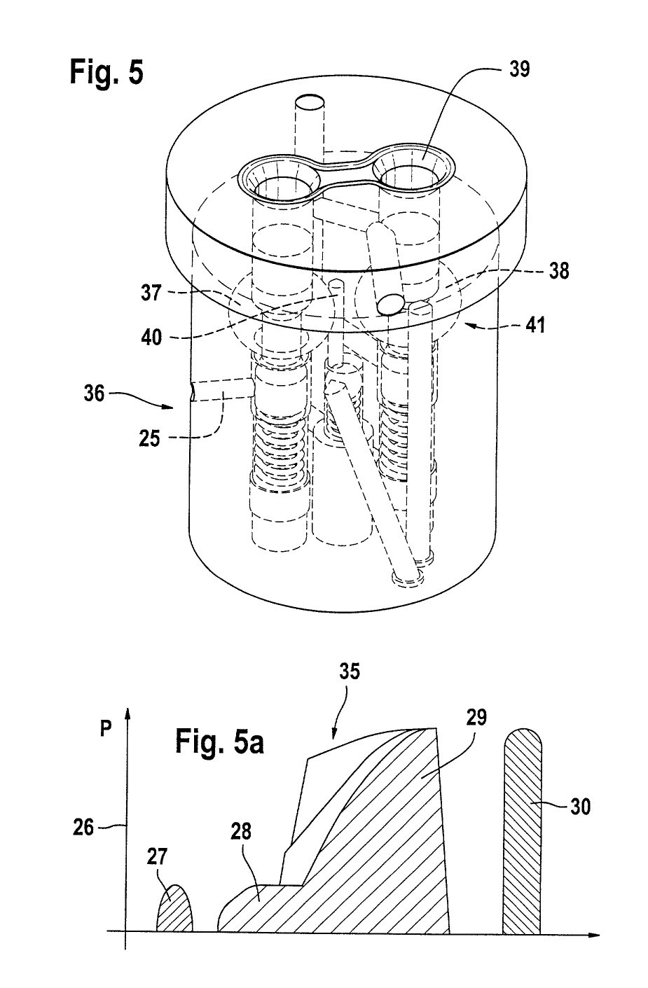

The schematic depiction of a further modified hydraulic module can be inferred from the depiction in FIG. 5.

In contrast to the hydraulic modules 14 and 31, the further modified hydraulic module 36 contains only one 2/2-way valve 37, while the other control valve is embodied as a 2/3-way valve 38. The reference numeral 25 indicates a discharge line associated with the 2/2-way valve 37, while the reference numeral 40 indicates the discharge throttle of a control chamber, which protrudes into the lower region of the further modified hydraulic module 36. The reference numeral 41 indicates the closed position of the two valves 37, 38. The further modified hydraulic module 36 according to the depiction in FIG. 5 is also provided with a hydraulic coupling chamber 39, which can be used for the parallel triggering of the two valves 37 and 38 by means of an actuator.

The injection pressure curve that can be produced with the further modified hydraulic module 36 can be inferred in more detail from FIG. 5a.

An injection phase 27, which has a relatively low pressure maximum, is followed by a pressure increase phase 28 (boot phase). The valve in the bore 38 remains partially open, as a result of which the full pressure is not built up (3^{rd} switch position). The boot phase 28 is followed by a main injection 29. In accordance with the further modified hydraulic module 36 according to FIG. 5, since there is a control chamber 32 analogous to the configuration embodied in FIG. 2 in addition to the control of the nozzle chamber 4, different pressure gradients 35 according to FIG. 5a can be produced at the nozzle needle 3, which is triggered with the further modified hydraulic module 36, in order to bring about the main injection. The main injection phase 29 is followed by a secondary injection 30, whose pressure maximum corresponds approximately to the pressure maximum that occurs during the main injection 29.

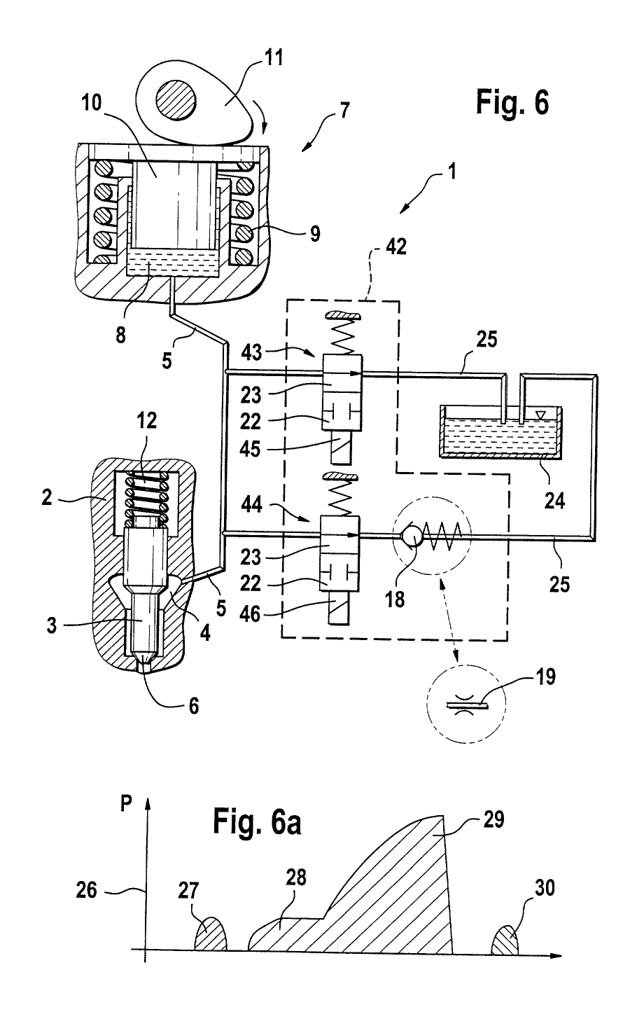

A more detailed schematic diagram of an electromagnetically actuated hydraulic module can be inferred from FIG. 6.

The compression unit 7 of the injector 1 according to the depiction from FIG. 6 contains a pump chamber 8 into which a piston element 10 protrudes. On the one hand, the piston element 10 is acted on with a restoring force by a spring and on the other hand, the piston element 10 is set into vertical motion by an eccentric cam 11 supported on a rotating shaft. As a result, highly pressurized fuel travels through the pressure line 5 into the nozzle chamber 4, which encloses the nozzle needle 3 of the injector 1 in the injector housing 2.

By means of the pressure line 5, action is exerted on a hydraulic module 42, which contains two electromagnetically actuated 2/2-way valves 43 and 44. The magnet coils 45 and 46 that actuate these valves are schematically sketched adjacent to them. The electromagnetically actuated hydraulic module 42 according to the depiction in FIG. 6 corresponds essentially to the embodiment of an actuator-actuated hydraulic module 14 shown above in the schematic diagram in FIG. 1. Analogous to the depiction of the actuator-actuated hydraulic module 14 according to FIG. 1, it can be inferred from the depiction of the hydraulic module 42 according to FIG. 6 that the second 2/2-way control valve 44 can either be associated with a constant pressure valve 18 or a throttle element 19.

The first 2/2-way valve 43 is connected to a discharge line 25, as is the second 2/2-way valve 44, via which the hydraulic module 42 and therefore the pressure line 5 can be pressure relieved into a reservoir 24.

Since the hydraulic module 42 essentially corresponds to the hydraulic module 14 according to FIG. 1 except for the manner in which it is actuated, the injection pressure curve 26 shown in FIG. 6a corresponds to the discharge rate curve shown in FIG. 1a, with a preinjection phase 27, pressure increase phase 28 (boot phase), and subsequent gradual pressure increase during the main injection 29. The end of the main injection 29 is followed by a secondary injection 30, whose pressure maximum essentially corresponds to the pressure maximum that occurs during the preinjection phase 27; with increasing secondary injection quantity, however, this maximum can still be exceeded.

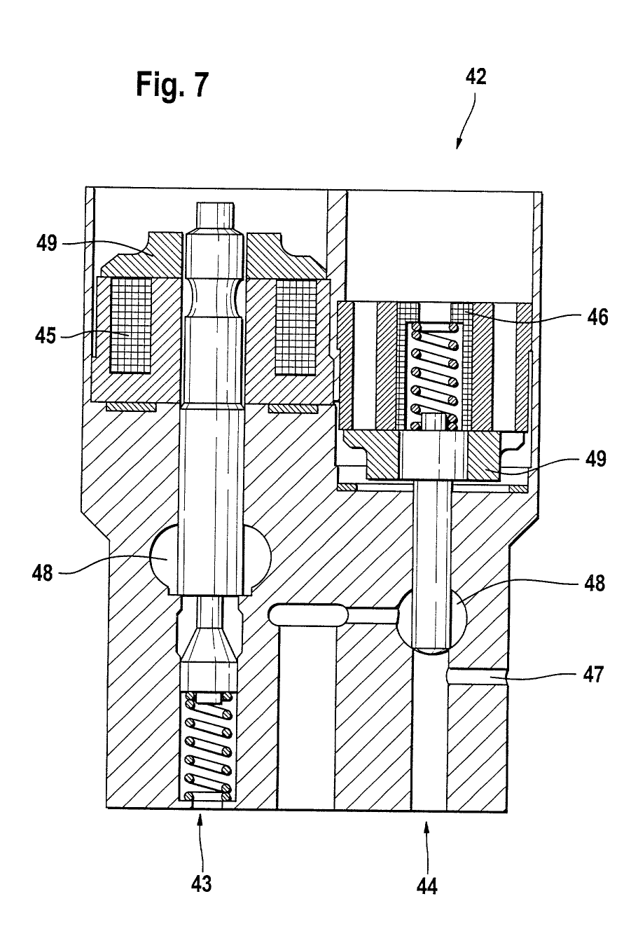

FIG. 7 shows an exemplary embodiment of an electromagnetically actuated actuator, with control valves disposed in parallel.

FIG. 7 shows a schematic view of an electromagnetically actuated hydraulic module 42. The two control valves 43 and 44 are disposed parallel to each other, slightly offset vertically in the hydraulic module 42. The magnet coils 45, 46 cooperate with armature plates incorporated into the valve needles of the control valves 49, which armature plates transfer vertical movement, which is produced by the supply of power to the magnet coils 45, 46, to the control bodies of the control valves 43 and 44. The second 2/2-way valve is associated with an annular chamber 48, which can be pressure relieved via a discharge line 42 and also communicates with the control chamber that is disposed centrally in relation to the symmetry line of the hydraulic module 42 according to the depiction in FIG. 7.

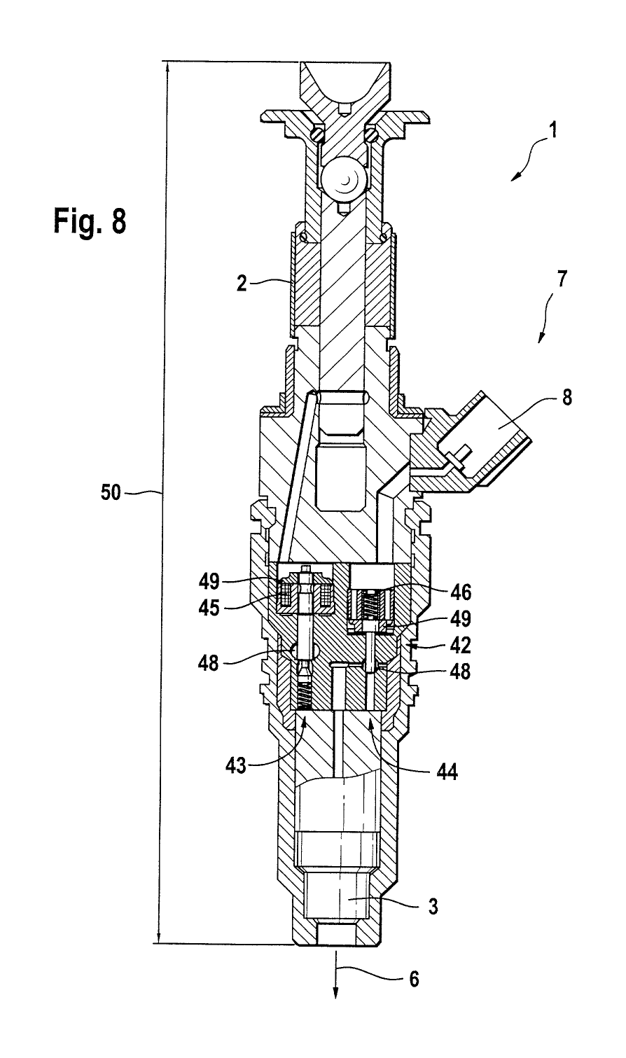

Finally, FIG. 8 shows the electromagnetically actuated hydraulic module, which is contained in an injector housing, in its installed position.

The height of the injector 1 according to the depiction in FIG. 8 is indicated with the reference numeral 50; the compression unit 7 that can be schematically inferred from FIGS. 1, 2, and 6 has been left out in the depiction according to FIG. 8. The compression unit 7 can be used to act on the hydraulic module 42 with highly pressurized fuel.

Whether they are electromagnetically actuated like the hydraulic module 42 or are actuated by means of an actuator like the hydraulic modules 14, 31, and 36, which are described in the preceding figures and have 2/2-way valves, 2/3-way valves, constant pressure elements, or throttle elements, the hydraulic modules are embodied in a standardized manner at their ends oriented toward and away from the injection nozzle 6 so that the hydraulic modules 14, 31, 36, and 42 can easily be replaced in the injector housing 2 of the injector 1. The hydraulic modules represent the components of an injector 1, which determine the discharge rate curve, where the various injection pressure curves that can be produced with the different embodiments of the hydraulic modules 14, 31, and 36 are shown by way of example in FIGS. 3a, 4a, and 5a. Depending on the pressure level in the preinjection phase and/or the pressure level in the pressure increase phase 28, these parameters can be adjusted through the dimensioning of the hydraulic modules 14, 31, 36, and 42, as can the pressure gradients 35 occurring in the curve of the main injection phase 29. Likewise, the modularity of the hydraulic modules used permits the absolute magnitude of the pressure, which occurs during the secondary injection phase 30, to be determined. By installing different hydraulic modules in an otherwise structurally identical injector, an extremely wide variety of injection pressure curves, i.e. formed discharge rate curves, can be achieved, which could only be achieved otherwise by means of control units via various control parameters and at a corresponding expense. Therefore the embodiment proposed according to the invention offers an advantageous possibility for producing two different injection pressure curves with minimal changes to standardized injector housings so that the entire spectrum of requirements for different injection pressure curves can be fulfilled.

The foregoing relates to preferred exemplary embodiment of the invention, it being understood that other variants and embodiments thereof are possible within the spirit and scope of the invention, the latter being defined by the appended claims.

1. An injector for injecting fuel into a combustion chamber of an internal combustion engine, the injector comprising
a compression unit (7) for compressing fuel to be supplied via a pressure line (5) to the nozzle chamber (4), which encompasses a nozzle needle (3) of the injector and communicates with the injection nozzle (6) protruding into the combustion chambers of the internal combustion engine, and
the injector (1) containing a fluid control unit, embodied as a hydraulic module (14, 31, 36, 42), which is replaceably disposed in the housing (2) of the injector (1), the hydraulic module being actuated either by an actuator or electromagnetically actuated.

2. The injector according to claim 1 wherein the actuator-actuated, replaceable hydraulic modules (14, 31, 36) are provided with a hydraulic coupling chamber (15, 39) on the end of the hydraulic module (14, 31, 36) oriented away from the nozzle needle (3).

3. The injector according to claim 2 wherein the actuator-actuated, replaceable hydraulic module (14, 31) contains 2/2-way valves (16, 17) that can be acted on via the hydraulic coupling chamber (15), and wherein one of the 2/2-way valves (16, 17) is preceded or followed by a constant pressure valve (18).

4. The injector according to claim 2 wherein one of the 2/2-way valves (16,17), which are contained in the actuator-actuated, replaceable hydraulic module (14, 31) and can be acted on by means of the coupling chamber (15), is associated with a throttle element (18, 19).

5. The injector according to claim 2 wherein the actuator-actuated, replaceable hydraulic module (36) contains a 2/2-way valve (37) and a 2/3-way valve (38).

6. The injector according to claim 1 wherein the replaceable, electromagnetically actuated hydraulic module (42) contains 2/2-way valves (43, 44), which can be actuated by means of magnet coils (45, 46), and wherein the 2/2-way valves (43, 44) are accommodated parallel to each other in the hydraulic module (42).

7. The injector according to claim 6 wherein the replaceable, electromagnetically actuated hydraulic module (42) is equipped with magnet coils (45, 46) on its end oriented away from the injection nozzle (6).

8. The injector according to claim 6 wherein the electromagnetically actuated, replaceable hydraulic module (42) contains 2/2-way valves (43, 44), one of which is associated with a constant pressure valve (18).

9. The injector according to claim 6 wherein, in the electromagnetically actuated, replaceable hydraulic module (42), one of the 2/2-way valves (43, 44) is associated with a throttle element.

10. The injector according to claim 1 wherein the end of the hydraulic module (14, 31, 36, 42) oriented toward the injection nozzle (6) is disposed opposite from triggering mechanisms (32, 34, 12) of the nozzle needle (3).
